(19) United States
(12) Patent Application Publication
(10) Pub. No.: US 2026/0220991 A1
(43) Pub. Date: Jul. 30, 2026

(54) SYSTEM FOR THE TACTILE INPUT OF A CODE INTENDED FOR VISUALLY IMPAIRED PERSONS

(71) Applicant: SYSTEMES ET TECHNOLOGIES IDENTIFICATION (STID), Greasque (FR)

(72) Inventors: Cédric BERENGER, Pourrieres (FR); Vincent DUPART, Saint-Maximin-la-Sainte-Beaume (FR); Sylvain POITRAT, Greasque (FR); Jérôme SILVE, Rousset (FR)

(73) Assignee: SYSTEMES ET TECHNOLOGIES IDENTIFICATION (STID), Greasque (FR)

(21) Appl. No.: 19/146,102

(22) PCT Filed: Jan. 2, 2024
(86) PCT No.: PCT/FR2024/050002

§ 371 Date: Jul. 7, 2025

(30) Foreign Application Priority Data
Jan. 5, 2023 (FR) 23/00137

(51) Int. Cl. G07C 9/00; G06F 3/0485; G06F 3/0488; G07C 9/33

(52) U.S. Cl. CPC G07C 9/0069; G06F 3/0485; G06F 3/0488; G07C 9/33; G06F 2203/04808

(57) ABSTRACT

An entry system for entering a code, including: a touch panel generating a contact detection signal in response to a detection of a touch entry gesture; a processing unit configured to operate in an entry mode for selecting digits of a series including all or part of the digits “0” to “9”, by carrying out the following steps of: identifying that the touch entry gesture is executed in the form of a main drag which corresponds to the drag of at least one finger on the touch panel from a main starting location to a main end location; determining a drag vector of the main drag; selecting a digit of the first series on the basis of the drag vector independently of the main starting location.

### TECHNICAL FIELD

The invention relates to an entry system for entering a code on a touch panel. It relates more particularly to an entry system adapted to visually impaired or blind persons.

The invention finds a preferred, and non-limiting, application for a secure access control reader requiring the entry of a code to authorize access to a secure space, but can also find an application in other sectors such as electronic payment terminals, self-service distribution terminals (for example, automated cash dispenser, food dispenser, drinks dispenser, etc.) and more generally terminals provided with a touch panel such as telephones, touch tablets and computers or computer terminals.

### STATE OF THE ART

As is known, apparatuses requiring the entry of a code comprising a sequence of characters, and in particular comprising digits, have a keyboard provided with several keys assigned to respective characters including digits, and possibly also alphabetic characters and/or special characters, such as for example the characters “*” and “#”, and/or functional characters, such as for example a validation key for validating the code once entered, or a backspace or correction key for correcting an error in entering the code, or even a cancellation key for canceling the complete entry.

Each key typically has a visual representation of a symbol informing the user of its functionality: indication of the digit for entering the digit; indication of the alphabetical character; indication of the special character; indication of the functional character (or the function of the key), for example by a color, such as a green key for validating the code and a red key for canceling the entry; etc.

Typically, a keyboard can be a mechanical keyboard or a tactile keyboard. The technologies differ between the two keyboard models, but the principle remains common, namely that the keyboard comprises a plurality of discrete keys, and the user presses the keys to enter the associated characters. In a mechanical keyboard, the keys are mechanical keys or push keys; in a tactile keyboard, the keys are formed of discrete (usually hollow) detection surfaces, each associated with a tactile sensor based on a technology for capturing a press or a touch on the detection surface, such as capacitive technology, inductive technology or infrared technology.

It is also known, in particular from EP1271295, to use a virtual keyboard displayed on or under a touch panel associated with a display screen; we generally speak of a touch screen, conventionally used in mobile phones and tablets, and operating for example with capacitive technology, resistive technology or infrared technology. The advantage of such a touch panel is to be able to detect the displacements or drags of a finger on the touch panel, and also to be able to detect a finger contact at any location on the touch panel, or even to detect several simultaneous contacts (multipoint detection) on the touch panel.

In EP1271295, it is proposed that keys be associated with at least two characters, namely a main character visible in the center of the key, and at least one secondary character visible in a corner of the key. A simple press on such a key triggers the entry of the main character, while a press on this same key followed by a drag toward the corresponding corner triggers the entry of the concerned secondary character. Although suitable for minimizing the display size on a small screen, this solution is however unsuitable for a visually impaired person because it necessarily requires a visualization of the key to be pressed, whether for the main character or for the secondary character.

Generally, the visual representations (marking on a mechanical or tactile keyboard, and display of a virtual keyboard of touch screen as described for example in EP1271295) are difficult to access for persons with visual impairments, and are completely inaccessible to blind persons.

Solutions have been designed to make keyboards accessible to the visually impaired.

In accordance with European standard EN 13332-3 06-1999, the key “5” on mechanical and tactile keyboards is provided with a tactile referencing lug so that by moving his/her finger over the keyboard, the visually impaired person can identify this key by touch and use it as a reference point to locate the other keys; the key “2” is located above the key “5”, the key “4” to the left, the key “6” to the right, etc. Similarly, for mechanical keyboards of electronic payment terminals, embossing in the shape of an “O” and an “X” respectively are used so that the visually impaired person can locate the validation and cancellation keys.

However, such a solution is difficult to envisage for a touch panel of a touch screen, because such a touch panel is designed to be smooth in order to be able to freely drag one's finger and allow the detection of drags, and it is therefore not possible to provide a referencing relief which would hinder such drags. Furthermore, if such a referencing relief were nevertheless added to the smooth touch panel, there remains a difficulty which is that when the visually impaired person places a finger on the touch panel to look for this referencing relief, the finger will inevitably drag on the touch panel and lead to unwanted entry of digits and therefore to the entry of an incorrect code.

### SUMMARY OF THE INVENTION

The invention aims to address the problem posed by providing a solution for entering a code on a touch panel of a touch screen that is more accessible and ergonomic for visually impaired persons. The solution can also be used by a sighted person.

Thus, the invention relates to an entry system for entering a code comprising a sequence of characters including at least digits, said entry system comprising:
a touch panel configured to generate a contact detection signal in response to a detection of a touch entry gesture made by a user on the touch panel, said contact detection signal being indicative of contact of one or several fingers on the touch panel during the touch entry gesture;
a processing unit configured to acquire the contact detection signal generated by the touch panel and to select a single character according to the contact detection signal corresponding to the detected touch entry gesture.

This entry system is remarkable in that the processing unit is configured to operate in an entry mode for selecting digits from a first series of characters comprising all or part of the digits “0” to “9”, by carrying out the following steps of:
identifying that the touch entry gesture is executed in the form of a main drag which corresponds to the drag of at least one finger on the touch panel from a main starting location to a main end location where the main drag is interrupted by removal of the at least one finger, according to the contact detection signal;
determining a drag vector of the main drag, according to the contact detection signal;
selecting a digit from the first series of characters on the basis of said drag vector of the main drag, regardless of the main starting location on the touch panel.

In other words, the entry system is based, when it operates in the entry mode mentioned above, on recognition/interpretation by the processing unit of the presses and drags, performed with one or several fingers on the touch panel. This entry mode is therefore suitable for visually impaired persons, because it does not require viewing and aiming at a location on the touch panel to enter one of the digits of the first series of characters. It should be noted that this entry mode can of course also be used by sighted persons.

It should be noted that this entry mode may be the only entry mode implemented by the processing unit, or it may be a special mode among several entry modes, and for example among two entry modes, the other entry mode may be a classic mode adapted to sighted persons. According to one option, these two entry modes may be superimposable, so that there would be two ways of entering the same digit on the touch panel.

It should be noted, for the purposes of the present description, that the selection of a character by the processing unit means that the processing unit transmits this character as an input for the validation of the code. Each character selected by the processing unit forms a sequence of characters which is compared to the stored code, for example to authorize access, validate a payment, etc. This comparison of the sequence of characters selected by the processing unit can be done within the processing unit, or within a host system which receives the selected characters from the processing unit and which then compares them with the stored code.

In the case where the processing unit can operate in two entry modes, this process of selecting a character varies depending on whether the processing unit is in one mode or the other.

As indicated, the touch entry gesture performed on the touch panel by the person, whether visually impaired or not, generates a contact detection signal which is transmitted to the processing unit. This contact detection signal corresponds to the signal generated by the means implemented to detect contacts (in other words touches) on the touch panel, such as means based on one of the following technologies: capacitive technology, resistive technology or infrared technology.

Based on its analysis of the contact detection signal, the processing unit will then trigger a specific functionality. Each touch gesture (press or drag with one or several fingers) is associated with a specific functionality, such as selecting a digit comprised between “0” and “9”.

To determine the drag vector, recognition is based on a main starting location corresponding to a point on the touch panel on which the visually impaired person presses, then on the direction and sense of drag of the finger to a main end location corresponding to a point on the touch panel from which the visually impaired person takes off (or removes) his/her finger; the contact of the finger (or at least one finger) being maintained throughout the drag. To be able to drag his/her finger in any direction from the main starting location, it is still preferable to have the main starting location substantially in the center of the touch panel, which is easily accessible for a visually impaired person who can appreciate the dimensions of the touch panel by touch and thus place themselves more or less in the center.

Thus, the drag vector can be established based on the main starting location and the main end location.

In a first variant of the invention, the contact detection signal is generated following a delay during which the user presses on the screen with his/her finger(s), or during which he/she drags it (them).

In a second variant of the invention, the contact detection signal is generated if, after pressing or drag, the user lifts his/her finger(s).

Advantageously, the invention allows visually impaired users to enter his/her code by executing simple touch gestures on the touch panel.

Another advantage of the invention for enhancing the ergonomics of the entry system and further improving the user experience for visually impaired persons is that the main starting location does not correspond to a specific area of the front face of the touch panel. Indeed, the processing unit considers as the main starting location any area of the touch panel on which the user presses with his/her finger(s), before drag it (them) according to the drag direction associated with the desired digit. Thus, the visually impaired person only needs to locate the housing of the entry system in his/her environment (and possibly the edges of the touch panel if the touch panel does not cover the entire surface of the entry system presented to users). Once the visually impaired person has located the touch panel in space, he/she can “tactilely” input his/her code on any part of it. Such a context of use, which does not depend on the starting location of the finger, is therefore particularly practical and ergonomic for the visually impaired person.

A final advantage of the invention is to optimize the management of the codes by the processing unit, by preventing it from having to process too many occurrences of erroneous digits.

According to one possibility, the processing unit is configured to determine the drag vector of the main drag as corresponding to a vector from the main starting location to the main end location (which, as a reminder, corresponds to the location where the user lifts or takes off the at least one finger).

So, it doesn't matter if the drag is in a straight line or a curved line, what matters is the main end location to establish the drag vector; which is advantageous for a visually impaired person.

According to another possibility, the main drag corresponds to the drag of a single finger across the touch panel from the main starting location.

In other words, the processing unit is configured to determine that a single finger is placed on the touch panel (no matter where, at the main starting location), and that this single finger drags to the main end location, to deduce that it is a main drag, and then deduce the drag vector to select the associated digit.

According to a particular embodiment, the processing unit is configured to identify that the touch entry gesture is executed in the form of the main drag under the condition that a distance between the main starting location and the main end location is greater than or equal to a given minimum main distance.

Thus, the drag must be long enough in terms of distance to be considered a main drag; otherwise it is not a main drag and the processing unit does not select a digit on the basis of a drag vector.

In an advantageous embodiment, the first series of characters comprises N digits, N being an integer greater than or equal to 2 and less than or equal to 10, and the processing unit is configured to establish N main angular sectors distributed around the main starting location and oriented radially according to N distinct main selection directions with a given main central angle, each of the N main angular sectors being associated with a digit of the first series of characters;
and wherein the processing unit is configured to determine whether the drag vector of the main drag is contained in one of the N main angular sectors, and to select the digit of the first series of characters which is associated with said main angular sector.

In this way, there is a margin defined by the main central angle, to properly aim at the main selection direction. Indeed, the main central angle corresponds to the angle at the center of the main angular sector; the center corresponding to the main starting location. In other words, the drag vector of the main drag may not be exactly coincident with the main selection direction aimed at, it may in fact be angularly offset by more or less half of the main central angle.

Furthermore, the processing unit is configured to determine whether the drag vector of the main drag is contained in one of the N main angular sectors, by detecting in which main angular sector the at least one finger is lifted; in other words by detecting in which main angular sector the main end location is located.

Advantageously, the N main angular sectors are contiguous and distributed over 360 degrees around the main starting location, so that the drag vector of the main drag is always contained in one of the N angular sectors.

Thus, there is no dead sector that would not be associated with a digit; and in this case, the main central angle corresponds to 360/N degrees.

According to one characteristic of the invention, the first series of characters comprises eight digits, N then being equal to 8, which are the digits “1”, “2”, “3”, “4”, “6”, “7”, “8” and “9”, and when placed in a reference frame defined by a horizontal axis and a vertical axis:
the main selection direction associated with the digit “1” is a diagonal direction at 45 degrees relative to the horizontal axis, upward and to the left from the main starting location;
the main selection direction associated with the digit “2” is a vertical direction parallel to the vertical axis, upward from the main starting location;
the main selection direction associated with the digit “3” is a diagonal direction at 45 degrees relative to the horizontal axis, upward and to the right from the main starting location;
the main selection direction associated with the digit “4” is a horizontal direction parallel to the horizontal axis, to the left from the main starting location;
the main selection direction associated with the digit “6” is a horizontal direction parallel to the horizontal axis, to the right from the main starting location;
the main selection direction associated with the digit “7” is a diagonal direction at 45 degrees relative to the horizontal axis, downward and to the left from the main starting location;
the main selection direction associated with the digit “8” is a vertical direction parallel to the vertical axis, downward from the main starting location;
the main selection direction associated with the digit “9” is a diagonal direction at 45 degrees relative to the horizontal axis, downward and to the right from the main starting location.

Thus, the main starting location virtually corresponds to the location of the digit “5” in a conventional keyboard, and the visually impaired person will drag his/her finger (or fingers in a multi-finger variant for the main drag) toward the digits “1”, “2”, “3”, “4”, “6”, “7”, “8”, or “9” positioned virtually around the digit “5”. This procedure thus leads to a natural entry of these digits, simply by dragging his/her finger.

In other words, the touch gestures made by the visually impaired person on the touch panel and recognized by the processing unit for these digits correspond to the gestures that he/she would make on a conventional keyboard.

The starting location (called the main starting location) on which the user presses his/her finger(s) is equivalent to having located the key “5” in the center of the keyboard on a conventional keyboard.

With one or several fingers, the drag gesture performed from the starting location in the 8 possible directions amounts to searching for and then selecting the keys corresponding to the digits “1” to “4” and “6” to “9”.

In other words, for example, the keys “2” and “6” being located on a keyboard respectively above and to the right of the key “5”, the user drags his/her finger from the starting location respectively upward and to the right.

In this case, since N is equal to 8, if the eight main angular sectors are contiguous, then each main angular sector has a main central angle of 45 degrees; therefore each main angular sector corresponds to a sector having an angle of plus or minus 22.5 degrees around the corresponding main selection direction.

According to one characteristic of the invention, in the entry mode, the processing unit is configured to select digits in a second series of characters comprising at least digits distinct from the digits of the first series of characters, by carrying out the following steps of:
identifying that the touch entry gesture is executed in the form of a secondary gesture among several secondary gestures, according to the contact detection signal, said several secondary gestures being distinct from the main drag;
selecting a digit from the second series of characters as a function of the detected secondary gesture.

In the case where the first series of characters does not contain all the digits “0” to “9”, it is therefore advantageous to provide other types of touch entry gestures, namely secondary gestures, which are just as ergonomic or intuitive, in order to be able to select these other digits not covered by the first series of characters.

According to one possibility, one of the several of the secondary gestures is a secondary gesture called centralized gesture which is characterized by a pressing of at least one finger (and for example a single finger) on a central starting location and by removing the at least one finger on a central end location interrupting said centralized gesture, where the central end location is located in a circular central area centered at the central starting location and having a radius corresponding to a predefined limiting distance;
and in which the processing unit is configured to select a digit from the second series of characters in response to the identification of said centralized gesture, independently of the central starting location on the touch panel.

Thus, the processing unit is configured to identify such a centralized gesture according to the contact detection signal, and to select a digit, and only one digit, which is associated with such a centralized gesture, regardless of where the user presses at the start of the centralized gesture, as long as he/she removes (or takes off) the finger at a distance from the central starting location which is less than the limiting distance.

According to one characteristic, the limiting distance is less than or equal to the minimum main distance; which is advantageous for clearly distinguishing a main drag from a centralized gesture.

Advantageously, the second series of characters comprises the digit “5” which is associated with the centralized gesture.

As seen in the previously described embodiment, the digit “5” (virtually in the center of the conventional keyboard) is not accessible by the main drag, and it is therefore advantageous to provide a specific touch entry gesture for entering this digit “5”, which is not a drag to avoid confusion with the other digits “1”, “2”, “3”, “4”, “6”, “7”, “8” and “9”. In the present case, this specific touch entry gesture is in the form of a centralized gesture in which the finger is placed and then removed almost in the same place (or even exactly in the same place), regardless of the localization of the place where the finger is placed on the touch panel.

In other words, and in order to prevent the processing unit from selecting the digit “5” incorrectly and causing an error in the entry of the code, when the user presses the central starting location, the actual selection of the digit “5” can be made after the user has removed his/her finger(s) almost from the central starting location for a predefined duration; the term “almost” being characterized by the limiting distance, which allows a certain margin between the place where the finger is placed and the place where the finger is removed.

Thus, this centralized gesture can be defined by a comparison between the distance between the central starting location and the central end location where the press is interrupted by removal of the at least one finger, and this predefined limiting distance. In other words, this limiting distance reflects a certain tolerance to assess whether a touch entry gesture is a centralized gesture or not. If this distance is less than the limiting distance, then the touch entry gesture is considered a centralized gesture; which is the case if the distance is zero. On the other hand, if this distance is greater than the limiting distance, then the touch entry gesture is not considered a centralized gesture.

Advantageously and as seen above, this limiting distance is equivalent to the minimum main distance described previously. Thus, if the distance (between pressing and lifting) is less than the minimum main distance, then the touch entry gesture is considered a centralized gesture, and if this distance is greater than the minimum main distance, then the touch entry gesture is considered a main drag or a secondary drag (described later) depending on the number of fingers.

Advantageously, the processing unit is configured to identify the touch entry gesture as the centralized gesture under the condition that a time interval between pressing the at least one finger on the central starting location and removing the at least one finger from the central end location is greater than a minimum press delay.

According to a first variant, the centralized gesture is a centralized press characterized by maintaining the at least one finger inside the circular central area between the central starting location and the central end location, so that the at least one finger remains inside said circular central area during the centralized press.

So, in this first variant, the at least one finger remains in the circular central area, and for example remains at the central starting location.

According to a second variant, the centralized gesture is a back and forth drag characterized by an exit of the at least one finger outside the circular central area between the central starting location and the central end location, such that the at least one finger exits said circular central area and returns inside the circular central area during the back and forth drag.

Thus, in this second variant, the at least one finger drags on the touch panel, leaving the central circular area then returning to the interior of the central circular area before being taken off; this back and forth drag thus forming a drag in the form of a closed loop, with a back and forth from the central circular area.

In a particular embodiment, one of the several secondary gestures is a secondary drag that corresponds to the drag of at least one finger on the touch panel from a secondary starting location to a secondary end location where the secondary drag is interrupted by removal of the at least one finger, said secondary drag being distinct from the main drag in that the main drag corresponds to the drag of a first number of fingers comprised between 1 and 4 (and preferably between 1 and 3), and the secondary drag corresponds to the drag of a second number of fingers comprised between 1 and 4 (and preferably between 1 and 3) and distinct from the first number of fingers;
and wherein the processing unit is configured to:
   determine a drag vector of the secondary drag, according to the contact detection signal;
   select a digit from the second series of characters on the basis of said secondary drag vector, regardless of the secondary starting location on the touch panel.

So, in the case where the first series of characters does not contain all the digits “0” to “9”, it is advantageous to select/search for the other digits not covered by the first series of characters (or even unencrypted characters as described later), again on the basis of a drag, but this time of a secondary drag which is distinguished from the main drag by the number of fingers involved in the drag. The principle therefore remains the same, but it is just the number of fingers which differs.

According to one possibility, the processing unit is configured to determine the drag vector of the secondary drag as corresponding to a vector from the secondary starting location to the secondary end location.

According to another possibility, the first number of fingers is 1 and the second number of fingers is 2.

In other words, the main drag is associated with the drag of a single finger to search for/select the digits of the first series of characters, while the secondary drag is associated with the drag of two fingers to search for/select the digit(s) of the second series of characters (or even unencrypted characters); preferably always referring to a classic keyboard as seen below.

According to another possibility, the processing unit is configured to identify that the touch entry gesture is executed in the form of the secondary drag under the condition that a distance between the secondary starting location and the secondary end location is greater than or equal to a given minimum secondary distance.

Advantageously, this minimum secondary distance is equivalent to the minimum main distance described previously.

Advantageously, the second series of characters comprises the digit “0” and the processing unit is configured to determine whether the drag vector of the secondary drag is contained in a secondary angular sector associated with the digit “0”, centered at the secondary starting location and oriented radially in a secondary selection direction with a given secondary center angle, and to select the digit “0” which is associated with said secondary angular sector.

In a special embodiment, the second series of characters also comprises K unencrypted characters, K being an integer greater than or equal to 2, and the processing unit is configured to establish (K+1) secondary angular sectors distributed around the secondary starting location and radially oriented in (K+1) distinct secondary selection directions with the given secondary center angle, one of the (K+1) secondary angular sectors being associated with the digit “0” and the others of the (K+1) secondary angular sectors being associated with the respective K unencrypted characters of the second series of characters;
and wherein the processing unit is configured to determine whether the drag vector of the secondary drag is contained in one of the (K+1) secondary angular sectors, and to select the digit “0” or the unencrypted character of the second series of character that is associated with said secondary angular sector.

Still advantageously, the secondary selection direction of the secondary angular sector associated with the digit “0” is, when placed in a reference frame defined by a horizontal axis and a vertical axis, a vertical direction parallel to the vertical axis, downward from the secondary starting location.

Conventionally, a conventional keyboard comprises, below the line formed by the keys corresponding to the digits “7”, “8”, and “9”, another line comprising, from left to right, the keys “*”, “0” and “#”. In terms of positioning, the key “0” is therefore disposed below the key “8”, which is itself disposed below the key “5”.

So that the processing unit to be able to dissociate the selection of a “0” from an “8”, the user, instead of performing a vertical downward drag with a first number of fingers (for example a single finger) to be in the case of a main drag from a location on the touch panel (regardless of the localization of this location) and then performing a downward drag (which amounts to selecting an “8”), executes the same touch gesture (vertical downward drag) but with a second number of fingers (for example two fingers) to select the “0”.

According to one characteristic of the invention, the K unencrypted characters comprise at least a first unencrypted character and a second unencrypted character, and when placed in a reference frame defined by a horizontal axis and a vertical axis:
the secondary selection direction associated with the first unencrypted character is a diagonal direction at 45 degrees relative to the horizontal axis, downward and to the left from the secondary starting location;
the secondary selection direction associated with the second unencrypted character is a diagonal direction at 45 degrees relative to the horizontal axis, downward and to the right from the secondary starting location.

Advantageously, the first unencrypted character is the special character “*” or a first letter (such as “A”), and the second unencrypted character is the special character “#” or a second letter (such as “B”).

The characters “*” (or the first letter) and “#” (or the second letter) are selected by performing a drag with the second number of fingers (for example two fingers) respectively from the bottom left and bottom right, thus respecting the format of a conventional keyboard.

Thus, the classic keyboard is “reproduced” in its entirety, and each digit or symbol is easily accessible to the visually impaired person, by using the appropriate main drag or secondary gesture (for example, centralized press, back and forth drag or secondary drag).

In one variant of the invention, in the case where the entry system is provided for a secure payment terminal, for which the keyboard generally comprises from left to right under the keys “*”, “0” and “#”, a red key (cancellation of the payment transaction), an orange key (backspace in the input of the PIN code of the bank card), and a green key (validation by the user of the code for verification by the card issuer), it is possible for the processing unit to recognize contact detection signals generated in response to drag on the touch panel performed with three fingers at the bottom left (red key), at the bottom (orange key), at the bottom right (green key).

According to one characteristic of the invention, in the special mode, the processing unit is configured to generate a vibratory feedback on the screen and/or an audible feedback when the digit is selected.

Advantageously, the feedback (whether sound and/or vibration) that the visually impaired user will hear or feel when his/her finger is placed on the touch panel will alert him/her that he/she has selected a digit.

According to one possibility, in the entry mode, the touch panel does not display any digits, and possibly nothing.

According to one characteristic of the invention, the entry system comprises a display screen positioned behind the touch panel, and the entry system is configured to operate in another entry mode, distinct from the entry mode, in which dedicated locations for entering the digits are displayed by means of the display screen on or under the touch screen, with one dedicated location per digit, and
in this other entry mode, the processing unit is configured to identify that the touch entry gesture is executed in the form of pressing one of the dedicated locations on the touch panel, and to select the single digit associated with said location.

Advantageously, and as mentioned previously, the entry system can also be intended for sighted person, in a mode called other entry mode (or sighted mode), while the entry mode (or visually impaired mode) described so far is suitable for visually impaired person. In this other entry mode, the entry system is conventional and displays a usual representation of a keyboard on or under the touch panel for entering the code, with dedicated locations for each digit. The representation may possibly differ in variants depending on whether the entry system is for example intended to be used in an access control reader, or in a secure payment terminal. As indicated, in this other entry mode, the processing unit is configured to select the single digit associated with a location when the user presses his/her finger on this location.

According to one characteristic of the invention, the entry system comprises at least one sensor connected to the processing unit which is configured to switch from the other entry mode to the entry mode upon receipt of at least one detection signal from the at least one sensor.

Advantageously, the at least one sensor is distinct from the means implemented by the touch panel for detecting the touch entry gesture performed by a user on the touch panel.

So there is no risk of erroneous switching.

In a first embodiment, the at least one sensor comprises a radio identification sensor in order to be able to detect an approach of a radio identification badge.

Thus, the visually impaired person brings his/her badge close to the touch panel to switch to the entry mode that is appropriate for him/her; this badge can be a card, a token, or integrated into a mobile terminal such as a telephone.

In one variant of the invention, the at least one sensor comprises at least one lateral approach sensor shaped to detect an approach or a contact of a user's hand on at least one side of the touch panel.

Thus, the entry system can switch from the other entry mode (or sighted mode) to the entry mode (or visually impaired mode) when a user touches or brings his/her hand closer to one side of the touch panel, to the right, to the left, above or below the front face of the touch panel on which the entry is performed; this bringing closer or this contact of the hand being detected by the lateral approach sensor (or one of the lateral approach sensors).

It should be noted that the side of the touch panel means, within the meaning of the present description, a lateral part extending next to the front face of the touch panel; in other words, this front face of the touch panel is clearly excluded from the definition of the side of the touch panel. Furthermore, when the touch panel is embedded in a locker and/or is integrated into a secure access control reader, then the side of the touch panel may correspond to the side of this locker and/or to the side of this reader.

Since a visually impaired person uses touch to locate, there is a high probability that he/she will touch the housing (or at least bring his/her hand close to it) in order to locate it in space. Advantageously, such an operating principle allows the entry system to be switched to the entry mode adapted to the visually impaired person before he/she begins inputting his/her code.

According to one possibility, the at least one lateral approach sensor is selected from a capacitive sensor, an inductive sensor, a radar sensor, an ultrasonic sensor, an optical sensor such as a camera, an accelerometer and a mechanical sensor.

In a particular embodiment, the at least one lateral approach sensor comprises at least one side sensor which is positioned on the at least one side of the touch panel.

By placing this side sensor on one side of the touch panel, it is easy to detect a hand approaching this side (or coming into contact with this side), as long as this hand approaches this side sensor.

As explained previously, this side sensor can be disposed directly on the side of the touch panel, and can also be disposed on the side of the locker and/or the reader.

According to one possibility, the at least one side sensor is selected from a capacitive sensor, an inductive sensor, a radar sensor, an ultrasonic sensor, an accelerometer, a camera and a mechanical sensor.

In an advantageous embodiment, the at least one side sensor comprises several side sensors disposed on several sides of the touch panel, or a peripheral sensor extending on several sides of the touch panel.

This allows the hand to approach the touch panel from several sides, or even from any side, to activate the entry mode adapted to the visually impaired person.

In another embodiment, the at least one lateral approach sensor comprises at least one front sensor which is positioned on the front face of the touch panel on which the touch keys are disposed, such a front sensor having a detection field making it possible to detect the approach or contact of the user's hand on the at least one side of the touch panel.

Thus, in this variant, the lateral approach sensor is not positioned on the side of the touch panel (as is the case with the side sensor), but is positioned on the front face of the touch panel, while being able to detect the approach or contact of the user's hand on the side of the touch panel thanks to a wide detection field.

According to another possibility, the at least one front sensor is selected from a radar sensor, an ultrasonic sensor, and a camera.

In one embodiment, the processing unit, when in entry mode, is configured to automatically switch from the entry mode to the other entry mode once the sequence of digits forming the code has been selected.

So this other entry mode (or sighted mode) is the default mode.

In one variant of the invention, the entry system switches from the entry mode (or visually impaired mode) to the other entry mode (or sighted mode) according to the same operating principle as that described above, or alternatively after a time period has passed during which the processing unit does not detect a touch gesture on the touch panel (for example, a time period of a few seconds), or even after the visually impaired person has validated their code and it is correct.

In a third variant, in order to improve the ergonomics and user experience of the entry system for visually impaired person, the transition from the other entry mode (or sighted mode) to the entry mode (or visually impaired mode), and vice versa, may be accompanied by vibratory feedback/haptic feedback when he/she touch the touch panel and/or an audible signal to warn him/her of the switch. If also an audible signal is provided to warn the user that a digit has been selected, it is conceivable that the audible signal provided for the mode switch is the same as that used for the selection of a digit, or else is different (in the case of an application context where it would be necessary to distinguish them).

The invention also relates to a secure access control reader comprising an entry system as previously described.

The invention also relates to an entry method for entering a code comprising a sequence of digits on a touch panel, said entry method being carried out on an entry system according to the invention, and comprising the following steps of:
generating a contact detection signal in response to a detection of a touch entry gesture performed by a user on the touch panel, said contact detection signal being indicative of contact of one or several fingers on the touch panel during the touch entry gesture;
acquiring by a processing unit the contact detection signal generated by the touch panel;
selecting by the processing unit a single character according to the contact detection signal corresponding to the detected touch entry gesture;
said entry method comprising an entry mode for selecting digits from a first series of characters comprising all or part of the digits “0” to “9”, and in which the processing unit carries out the following steps of:
identifying that the touch entry gesture is executed in the form of a main drag which corresponds to the drag of at least one finger on the touch panel from a main starting location to a main end location where the main drag is interrupted by removal of the at least one finger, according to the contact detection signal;
determining a drag vector of the main drag, according to the contact detection signal;
selecting a digit from the first series of characters on the basis of said drag vector of the main drag, regardless of the main starting location on the touch panel.

Of course, all the characteristics previously mentioned for the entry system also apply to the entry method.

### BRIEF DESCRIPTION OF THE FIGURES

Other characteristics and advantages of the present invention will appear on reading the detailed description below, of a non-limiting example of implementation, made with reference to the appended figures in which:

FIG. 1 is a schematic view of an entry system in an entry mode adapted to the visually impaired person, where a main drag from a main starting location to a main end location is illustrated allowing the selection of the digit “3” belonging to a first series of characters;

FIG. 2 is a schematic view of the entry system with an illustration of eight main angular sectors centered at the main starting location of FIG. 1 and associated with the respective digits “1”, “2”, “3”, “4”, “6”, “7”, “8” and “9” of the first series of characters;

FIG. 3 is a schematic view equivalent to that of FIG. 2, where a main drag is illustrated allowing the selection of the digit “9”;

FIG. 4 is a schematic view equivalent to that of FIG. 2, where a main drag is illustrated allowing the selection of the digit “4”;

FIG. 5 is a schematic view equivalent to that of FIG. 2, but with another main starting location;

FIG. 6 is a schematic view of the entry system in the entry mode adapted to the visually impaired person, where a press centralized at a central starting location and allowing the selection of the digit “5” belonging to a second series of characters is illustrated;

FIG. 7 is a schematic view equivalent to that of FIG. 2, where a central area centered at the central starting location of FIG. 6 and associated with the selection of the digit “5” is illustrated;

FIG. 8 is a schematic view equivalent to that of FIG. 7, where a centralized support is illustrated allowing the selection of the digit “5”;

FIG. 9 is a schematic view equivalent to that of FIG. 7, where a back and forth drag is illustrated allowing the selection of the digit “5”;

FIG. 10 is a schematic view of the entry system in the entry mode adapted to the visually impaired person, where a secondary drag from a secondary starting location to a secondary end location is illustrated allowing selection of the special character “*” belonging to the second series of characters;

FIG. 11 is a schematic view of the entry system with an illustration of three secondary angular sectors centered at the secondary starting location of FIG. 10 and associated with the special characters “*” and “#” and the digit “0” of the second series of characters;

FIG. 12 is a schematic view equivalent to that of FIG. 11, where a secondary drag is illustrated allowing the selection of the digit “0”;

FIG. 13 is a schematic view of the entry system in a version with a display screen and in the other entry mode adapted to the sighted persons in which the keys of a virtual keyboard are displayed;

FIG. 14 is a schematic view equivalent to that of FIG. 13, where a press is illustrated allowing the selection of the digit “7” in this other entry mode adapted to sighted persons;

FIG. 15 is a schematic view of a secure access control reader integrating the entry system, with a user entering a code.

### DETAILED DESCRIPTION OF ONE OR SEVERAL EMBODIMENTS OF THE INVENTION

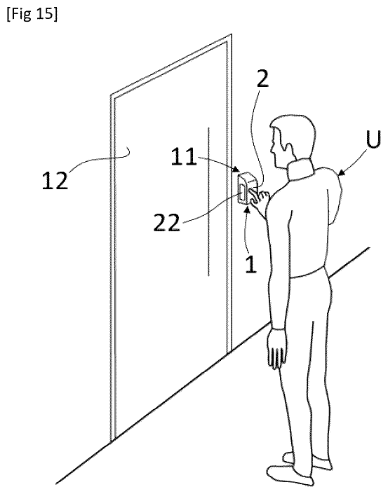

With reference to the Figures, an entry system 1 according to an exemplary embodiment of the invention comprises a touch panel 2 having a completely flat and smooth front face on which a user U (illustrated in FIG. 15) can place one or several fingers. This touch panel 2 is configured to generate a contact detection signal 20 in response to detection of a touch entry gesture performed by the user U on the touch panel 2 (and more precisely on its front face). The front face of the touch panel 2 extends in a plane defined by a horizontal axis H and a vertical axis V; these two axes H, V defining a reference frame for establishing coordinates on the touch panel 2.

This contact detection signal 20 is indicative of contact of one or several fingers on the front face of the touch panel 2 during the touch entry gesture, and it integrates information as to the number of fingers which come into contact with the front face (for example based on a contact surface), the localization of the initial location on which the finger(s) come into contact with the touch panel 2 at the start of the touch entry gesture, the localization of the final location on which the finger(s) are took off and break contact with the touch panel 2 at the end of the touch entry gesture. This contact detection signal 20 may optionally also include information as to the localization of one or several points of passage of the finger(s) which would drag on the touch panel 2 from the initial location to the final location.

This entry system 1 further comprises a processing unit 3 which is connected to the touch panel 2 to acquire the contact detection signal 20 generated by the touch panel 2 and which is configured to select a single character according to the contact detection signal 20 corresponding to the detected touch entry gesture. In other words, the processing unit 3 selects a character according to the contact detection signal 20 which is representative of the touch entry gesture carried out by the user U on the touch panel 2. This processing unit 3 can be a processor, a controller, an electronic card or a computer terminal.

Thus, the entry system 1 makes it possible to enter a code comprising a sequence of characters including at least digits, and the processing unit 3 is configured to operate in an entry mode adapted to the visually impaired person, and subsequently called visually impaired mode, to select the characters by means of dedicated touch entry gestures adapted to the visually impaired person.

With reference to FIG. 15, this entry system 1 can be integrated with a secure access control reader 11 for entering an access code authorizing access to a secure area, for example for opening a door 12 or an access barrier.

In the example described, the characters are divided into two series of characters in the visually impaired mode, which are:
a first series of characters comprising eight digits which are the digits “1”, “2”, “3”, “4”, “6”, “7”, “8” and “9”; and
a second series of characters comprising the digits “5” and “0”, and also optionally the special characters “*” and “#”.

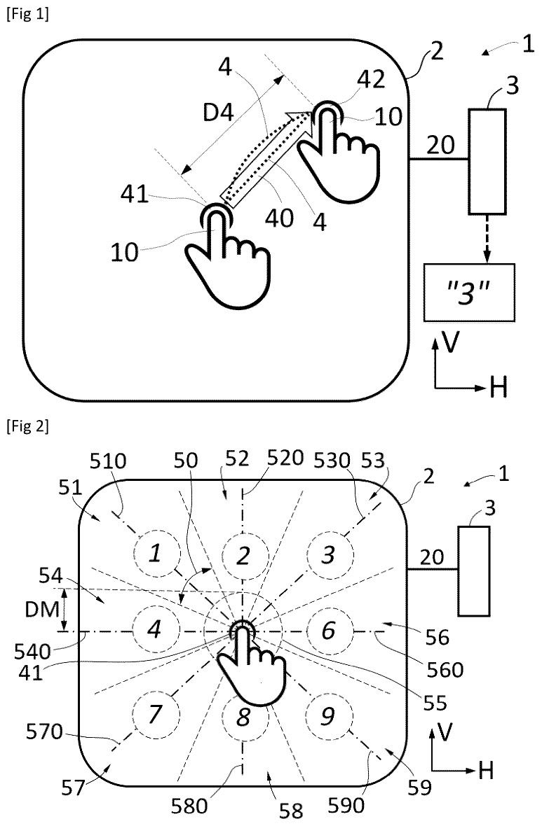

Referring to FIGS. 1 to 5, in the visually impaired mode, the processing unit 3 is configured to select digits from the first series of characters, by carrying out the following steps of:
identifying, according to the contact detection signal 20, that the touch entry gesture is executed in the form of a main drag 4 which corresponds to the drag of a single finger 10 on the touch panel 2 from an initial location, called the main starting location 41, to a final location, called the main end location 42, where the main drag 4 is interrupted by removing the finger 10
determining a drag vector 40 of the main drag 4, according to the contact detection signal 20;
selecting a digit from the first series of characters on the basis of this drag vector 40 of the main drag 4, independently of the main starting location 41 on the touch panel 2.

In the example of FIG. 1, two examples of main drag 4 are schematized in the form of two dotted lines, with a first line which is straight from the main starting location 41 to the main end location 42 reflecting that the main drag 4 is in a straight line, and a second line which is curved from the main starting location 41 to the main end location 42 reflecting that the main drag 4 is in a curved line.

More specifically, the processing unit 3 is configured to determine the drag vector 40 of the main drag 4 as corresponding to a vector from the main starting location 41 to the main end location 42.

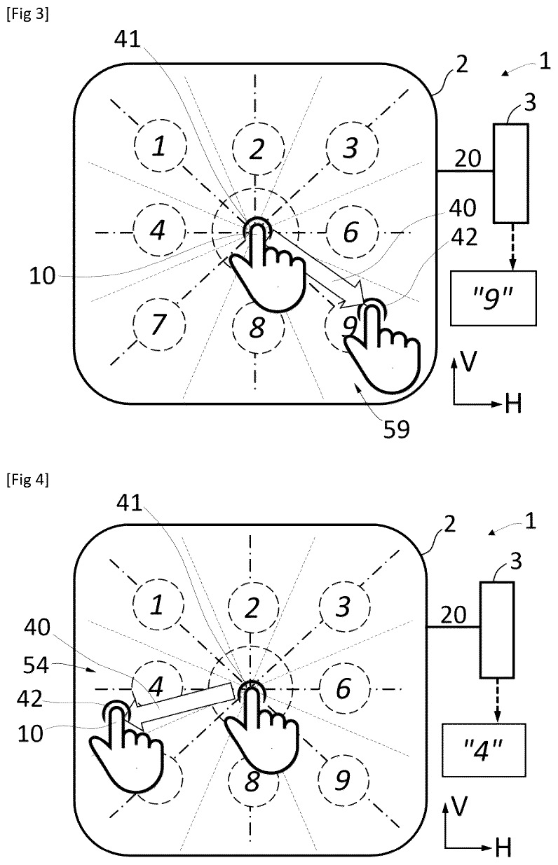

Thus, in the case where the main drag 4 is in a straight line then the drag vector 40 is superimposed on this straight line, and in the case where the main drag 4 is in a curved line then the drag vector 40 is not superimposed on this curved line; what counts to determine the drag vector 40 is therefore the relative position of the main end location 42 with respect to the main starting location 41, regardless of the path of the finger 10 to go from the main starting location 41 to the main end location 42. In FIGS. 3 and 4, only the drag vector 40 is illustrated.

Furthermore, the processing unit 3 is configured to identify that the touch entry gesture is executed in the form of the main drag 4 under the condition that a distance D4 between the main starting location 41 and the main end location 42 is greater than or equal to a given minimum main distance DM.

Thus, by analyzing the contact detection signal 20, the processing unit 3 determines the coordinates of the main starting location 41 and of the main end location 42, then calculates the distance D4 to compare it with the minimum main distance DM, deduces therefrom the drag vector 40 of the main drag 4, and finally determines the digit of the first series of characters according to this drag vector 40 of the main drag 4.

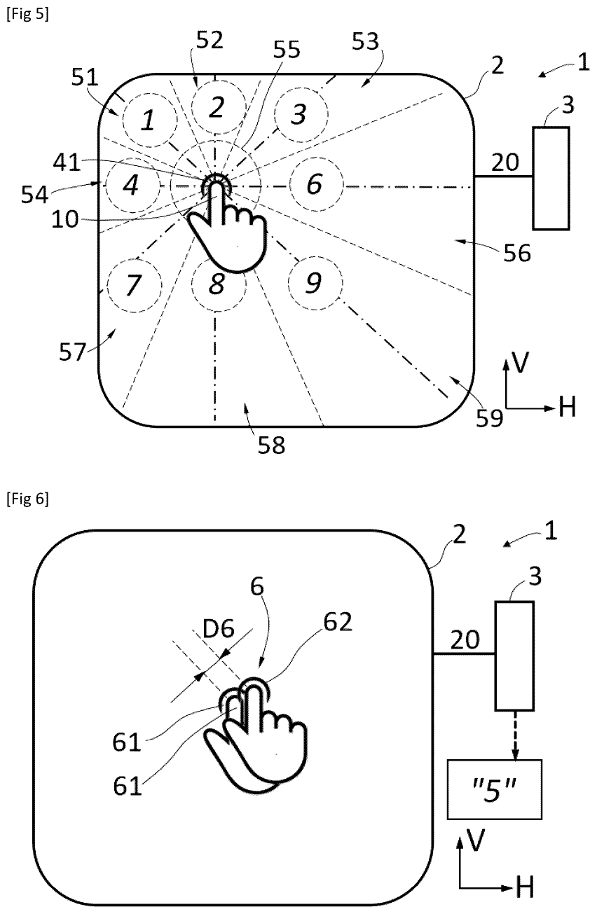

For this determination of the digit and with reference to FIGS. 2 and 5, the processing unit 3 is configured to:
establish eight main angular sectors 51, 52, 53, 54, 56, 57, 58, 59 contiguous, distributed around the main starting location 41 and oriented radially in eight distinct main selection directions 510, 520, 530, 540, 560, 570, 580, 590 with a given main central angle 50, each of the eight main angular sectors 51, 52, 53, 54, 56, 57, 58, 59 being associated with a digit “1”, “2”, “3”, “4”, “6”, “7”, “8”, “9” of the first series of characters; and
determine whether the drag vector 40 of the main drag 4 is contained in one of the eight main angular sectors 51, 52, 53, 54, 56, 57, 58, 59, and to select the digit of the first series of characters which is associated with said main angular sector.

As illustrated in FIGS. 2 and 5, the minimum main distance DM can be characterized by a central area 55 of circular shape centered at the main starting location 41 and whose radius corresponds to the minimum main distance DM. Thus, when the user U places his/her finger 10 on the touch panel 2 and wants to enter one of the digits “1”, “2”, “3”, “4”, “6”, “7”, “8”, “9”, his/her finger 10 must drag to leave this central area 55 and reach one of the eight main angular sectors 51, 52, 53, 54, 56, 57, 58, 59. Also, these eight main angular sectors 51, 52, 53, 54, 56, 57, 58, 59 are distributed around this central area 55.

For the last sub-step, the localization of the drag vector 40 in one of the eight main angular sectors 51, 52, 53, 54, 56, 57, 58, 59 can be determined simply by determining in which of the eight main angular sectors 51, 52, 53, 54, 56, 57, 58, 59 the main end location 42 is located, in other words in which from the eight main angular sectors 51, 52, 53, 54, 56, 57, 58, 59 the user U lifts his/her finger 10. In the example of FIG. 3, the main end location 42 is located in the main angular sector 59 associated with the digit “9”, so that the processing unit 3 selects this digit “9”. In the example of FIG. 4, the main end location 42 is located in the main angular sector 54 associated with the digit “4”, so that the processing unit 3 selects this digit “4”.

It is recalled that the construction of these eight main angular sectors 51, 52, 53, 54, 56, 57, 58, 59 is done around the main starting location 41, regardless of the localization of this main starting location 41 on the touch panel 2, as visible in FIG. 2 with a main starting location 41 substantially in the center of the touch panel 2 and in FIG. 5 with a main starting location 41 offset from the center of the touch panel 2.

FIGS. 2 to 5 illustrate the construction lines of the main angular sectors 51, 52, 53, 54, 56, 57, 58, 59, the lines of the main selection directions 510, 520, 530, 540, 560, 570, 580, 590, as well as the digits “1”, “2”, “3”, “4”, “6”, “7”, “8”, “9” associated with them and represented within circles in broken lines; however, in use, these lines and these digits are not visible or displayed on or under the touch panel 2, in other words nothing is displayed or visible on the touch panel 2 as illustrated in FIG. 1 which schematically illustrates a main drag 4 which allows the selection of the digit “3”.

To be more precise on the main angular sectors 51, 52, 53, 54, 56, 57, 58, 59, the main central angle 50 is 45 degrees, and the main selection directions 510, 520, 530, 540, 560, 570, 580, 590 are uniformly distributed every 45 degrees around the main starting location 41, so that:
the main selection direction 510 associated with the digit “1” is a diagonal direction at 45 degrees relative to the horizontal axis H, upward and to the left from the main starting location 41;
the main selection direction 520 associated with the digit “2” is a vertical direction, parallel to the vertical axis V, upward from the main starting location 41;
the main selection direction 530 associated with the digit “3” is a diagonal direction at 45 degrees relative to the horizontal axis H, upward and to the right from the main starting location 41;
the main selection direction 540 associated with the digit “4” is a horizontal direction, parallel to the horizontal axis H, to the left from the main starting location 41;
the main selection direction 560 associated with the digit “6” is a horizontal direction, parallel to the horizontal axis H, to the right from the main starting location 41;
the main selection direction 570 associated with the digit “7” is a diagonal direction at 45 degrees relative to the horizontal axis H, downward and to the left from the main starting location 41;
the main selection direction 580 associated with the digit “8” is a vertical direction, parallel to the vertical axis V, downward from the main starting location 41;
the main selection direction 590 associated with the digit “9” is a diagonal direction at 45 degrees relative to the horizontal axis H, downward and to the right from the main starting location 41.

Thus, and as visible in FIG. 2, this distribution of the main angular sectors 51, 52, 53, 54, 56, 57, 58, 59 is equivalent to the distribution of the keys “1”, “2”, “3”, “4”, “6”, “7”, “8”, “9” in a conventional keyboard, so that the visually impaired person can naturally perform a main drag 4 to select one of these digits.

With reference to FIGS. 6 to 12, in the visually impaired mode, the processing unit 3 is configured to select the digits “0” and “5” in the second series of characters, by carrying out the following steps of:
identifying that the touch entry gesture is executed in the form of a secondary gesture among several secondary gestures, according to the contact detection signal 20, these several secondary gestures being distinct from the main drag 4 which is, as a reminder, a one-finger drag beyond the central area 55 described previously;
selecting a digit “0” or “5” from the second series of characters according to the detected secondary gesture.

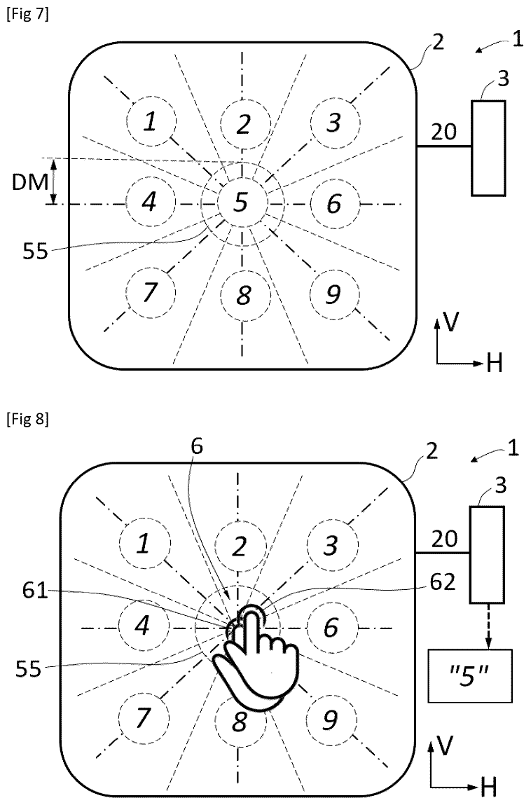

With regard to the selection of the digit “5”, the secondary gesture may be a touch entry gesture with a single finger, called centralized gesture 6, 7, and which is such that the final location (location where the user U takes off his/her finger 10) is located inside the central area 55; it being recalled that the central area 55 is a circle centered at the initial location (location where the user U places his/her finger 10) and whose radius corresponds to the minimum main distance DM. Thus, this central area 55 is associated with the digit “5”, as illustrated in FIG. 7.

In other words and with reference to FIGS. 6 to 9, this centralized gesture is characterized by pressing the finger 10 on a central starting location 61, 71 and by removing the finger 10 on a central end location 62, 72 interrupting said centralized gesture, where the central end location 62, 72 is located in the circular central area 55 centered at the central starting location 61, 71 and having a radius corresponding to a predefined limiting distance less than or equal to the minimum main distance DM; where in the examples illustrated the limiting distance is equal to the minimum main distance DM.

In this case, the processing unit 3 is configured to select the digit “5” from the second series of characters in response to the identification of such a centralized gesture 6, 7, independently of the central starting location 61, 71 on the touch panel 2.

Two variants are possible for this centralized gesture 6, 7 allowing the selection of the digit “5”.

In a first variant illustrated in FIGS. 6 and 8, the centralized gesture is such that the finger 10 does not leave the central area 55, and this centralized gesture is called centralized press 6; in other words, this centralized press 6 is characterized by maintaining the finger 10 inside the circular central area 55 between the central starting location 61 and the central end location 62, so that the finger 10 remains inside this circular central area 55 during the centralized press 6. Thus, the processing unit 3 is configured to select the digit “5” in response to the identification of such a centralized press 6, independently of the central starting location 61 on the touch panel 2.

The processing unit 3 can be configured to identify the touch entry gesture as the centralized press 6 under the condition that a time interval between placing the finger on the central starting location 61 and removing (or taking off) the finger is greater than a minimum press delay. Thus, the centralized press 6 can be a press on the central starting location 61 without moving the finger before taking off it after a time greater than this minimum press delay.

As illustrated in FIG. 6, the processing unit 3 is configured to identify the touch entry gesture as the centralized press 6 under the condition that a distance D6 between the central starting location 61 and the central end location 62, where the centralized press 6 is interrupted by removing the finger, is less than the predefined limiting distance which is, as a reminder, less than or equal to the minimum main distance DM. In the illustrated example, this limiting distance is equal to the minimum main distance DM.

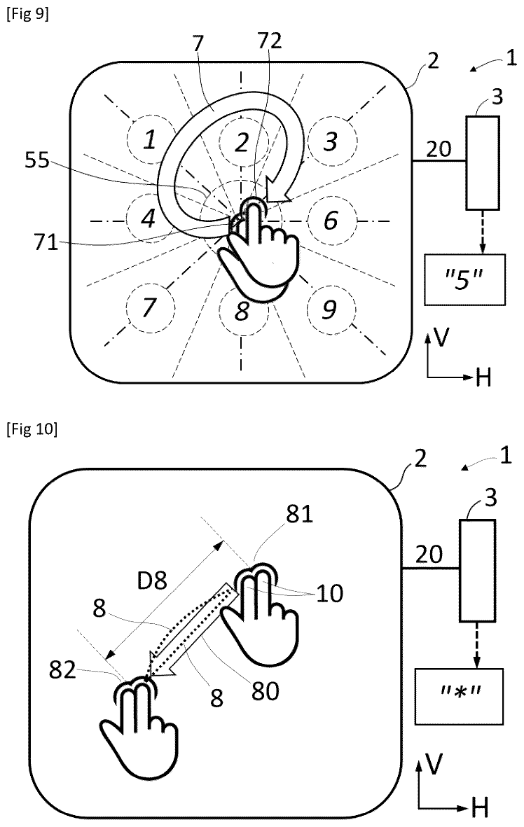

In a second variant illustrated in FIG. 9, the centralized gesture is such that the finger leaves the central area 55 and returns to the central area 55 where the finger 10 is taken off, and this centralized gesture is called back and forth drag 7; in other words, this back and forth drag 7 is characterized by an exit of the finger 10 outside the central area 55 between the central starting location 71 and the central end location 72, so that the finger 10 leaves the central area 55 and returns inside the central area 55 during the back and forth drag 7. In other words, the back and forth drag 7 corresponds to the drag of the finger on the touch panel 2 from the central starting location 71 (where the finger is placed) until a return to the central end location 72 which is the same as or close to the central starting location 71, where the back and forth drag 7 is interrupted by removing the finger.

Thus, the processing unit 3 is configured to identify the touch entry gesture as the back and forth drag 7 under the condition that a distance between the central starting location 71 and the central end location 72, where the press is interrupted by removing the finger, is less than a predefined limiting distance which is less than or equal to the minimum main distance DM. In the illustrated example, this limiting distance is equal to the minimum main distance DM.

Referring to FIGS. 10 to 12, in the visually impaired mode, the processing unit 3 is configured to select the digit “0”, and optionally also the special characters “*” and “#”, in the second series of characters, by carrying out the following steps of:
identifying, according to the contact detection signal 20, that the touch entry gesture is executed in the form of a secondary drag 8 which corresponds to the drag of two fingers 10 on the touch panel 2 from an initial location, called the secondary starting location 81, to a final location, called the secondary end location 82, where the secondary drag 8 is interrupted by removing the two fingers 10;
determining a drag vector 80 of the secondary drag 8, according to the contact detection signal 20;
selecting a character from the digit “0” and the special characters “*” “*” and “#” of the second series of characters according to this drag direction of the secondary drag 8, independently of the secondary starting location 81 on the touch panel 2.

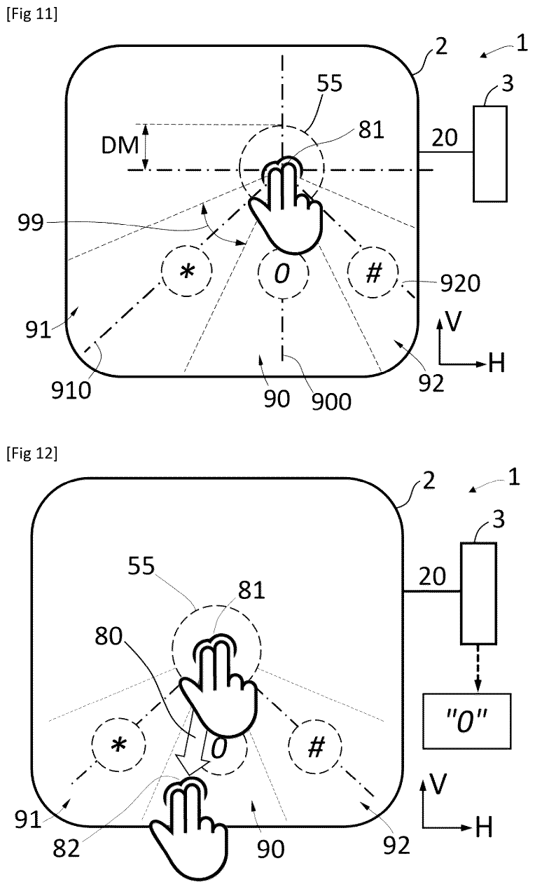

In the example of FIG. 10, two examples of secondary drag 8 are shown diagrammatically as two dotted lines, with a first line that is straight from the secondary starting location 81 to the secondary end location 82 reflecting that the secondary drag 4 is in a straight line, and a second line that is curved from the secondary starting location 81 to the secondary end location 82 reflecting that the secondary drag 8 is in a curved line. In FIG. 12, only the drag vector 80 is illustrated.

More specifically, the processing unit 3 is configured to determine the drag vector 80 of the secondary drag 8 as corresponding to a vector starting from the secondary starting location 81 and the secondary end location 82. Furthermore, the processing unit 3 is configured to identify that the touch entry gesture is executed in the form of the secondary drag 8 under the condition that a distance D8 between the secondary starting location 81 and the secondary end location 82 is greater than or equal to a given minimum secondary distance which, in the illustrated example, is equivalent to the minimum main distance DM.

Thus, by analyzing the contact detection signal 20, the processing unit 3 determines the coordinates of the secondary starting location 81 and of the secondary end location 82, then calculates the distance D8 to compare it with the minimum main distance DM, deduces therefrom the drag vector 80 of the secondary drag 8, and finally determines the character “0”, “*” or “#” of the second series of characters according to this drag vector 80 of the secondary drag 8.

For this determination of the character and with reference to FIG. 11, the processing unit 3 is configured to:
establish three contiguous secondary angular sectors 90, 91, 92, distributed around the secondary starting location 81 and oriented radially in three distinct secondary selection directions 900, 910, 920 with a given secondary center angle 99, each of the three secondary angular sectors 90, 91, 92 being associated with a character “0”, “*” or “#” of the second series of characters; and
determine whether the drag vector 80 of the secondary drag 8 is contained in one of the three secondary angular sectors 90, 91, 92, and to select the character which is associated with said secondary angular sector.

As illustrated in FIG. 10, the minimum main distance DM can be characterized by the central area 55 previously described. Thus, when the user U places two fingers 10 on the touch panel 2 and wants to enter one of the characters “0”, “*” or “#”, his/her two fingers 10 must drag to leave this central area 55 and reach one of the three secondary angular sectors 90, 91, 92. Also, these three secondary angular sectors 90, 91, 92 are distributed around this central area 55.

For the last sub-step, the localization of the drag vector 80 of the secondary drag 8 in one of the three secondary angular sectors 90, 91, 92 can be determined simply by determining in which of the three secondary angular sectors 90, 91, 92 the secondary end location 82 is located, in other words in which of the three secondary angular sectors 90, 91, 92 the user U takes off his/her two fingers 10. In the example of FIG. 10, the secondary end location 82 is located in the secondary angular sector 91 (not illustrated in this FIG. 10) associated with the special character “*”, so that the processing unit 3 selects this special character “*”. In the example of FIG. 12, the secondary end location 82 is located in the secondary angular sector 90 associated with the digit “0”, so that the processing unit 3 selects this digit “0”.

It is recalled that the construction of the three secondary angular sectors 90, 91, 92 is done around the secondary starting location 81, regardless of the localization of this secondary starting location 81 on the touch panel 2.

FIGS. 11 and 12 illustrate the construction lines of the secondary angular sectors 90, 91, 92, the lines of the secondary selection directions 900, 910, 920, as well as the associated characters “0”, “*” and “#” represented inside circles in broken lines; however, in use, these lines and these characters are not visible or displayed on or under the touch panel 2, in other words nothing is displayed or visible on the touch panel 2 as illustrated in FIG. 10 which schematically illustrates a secondary drag 8 which allows the selection of the special character “#”.

To be more precise on the secondary angular sectors 90, 91, 92, the secondary center angle 99 is 45 degrees, and the secondary selection directions 900, 910, 920 are uniformly distributed every 45 degrees around the secondary starting location 81, so that:
the secondary selection direction 910 associated with the special character is a diagonal direction at 45 degrees relative to the horizontal axis H, downward and to the left from the secondary starting location 81;
the secondary selection direction 900 associated with the digit “0” is a vertical direction, parallel to the vertical axis V, downward from the secondary starting location 81;
the secondary selection direction 920 associated with the special character “#” is a diagonal direction at 45 degrees relative to the horizontal axis H, downward and to the right from the secondary starting location 81.

Thus, and as visible in FIGS. 11 and 12, this distribution of the secondary angular sectors 90, 91, 92 is equivalent to the distribution of the keys “0”, “*” and “#” in a conventional keyboard, so that the visually impaired person can naturally perform a secondary drag 8 to select one of these characters.

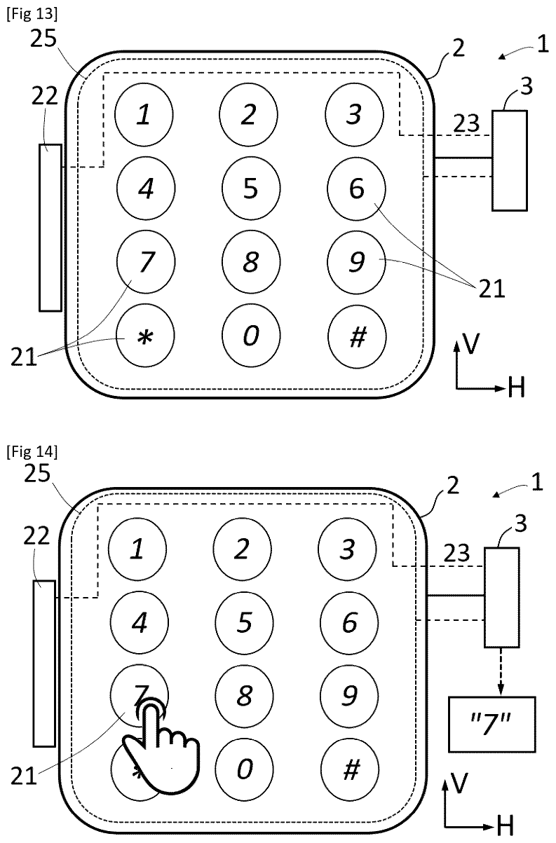

In a particular embodiment illustrated in FIGS. 13 and 14, the entry system 1 comprises a display screen 25 positioned behind the touch panel 2, thus forming a touch screen, and the control unit 3 is connected to this display screen 25 to drive the display on this display screen 25.

In this embodiment, the control unit 3 is configured to operate in another entry mode called sighted mode, distinct from the visually impaired mode described previously. In this sighted mode, the control unit 3 drives the display screen 25 to display on or under the touch panel 2 locations 21 dedicated to entering the digits “0” to “9”, and optionally also special characters such as “*” and “#”, with a dedicated location per digit and per character. For each location 21, the concerned digit or character is displayed. These locations 21 together form a virtual keyboard displayed on or under the touch panel 2, and visible from the front face of the touch panel 2.

In this sighted mode, the processing unit 3 is configured to identify that the touch entry gesture is executed in the form of a press on one of the dedicated locations 21 of the touch panel 2, and to select the single digit or character associated with said location 21. In the example of FIG. 14, a user U presses the location 21 dedicated to the digit “7” with a finger, so that the processing unit 3 selects the digit “7”. In this sighted mode, the localization of the digits and characters is essential for making the selection, unlike the visually impaired mode where the selection can be made regardless of the initial location. Also, in this sighted mode, it is necessary to see the dedicated locations 21 of the touch panel 2, whereas in the visually impaired mode it is not necessary to see.

Advantageously, the entry system 1 comprises at least one sensor 22 connected to the processing unit 3 which is configured to switch from sighted mode to visually impaired mode upon receipt of a detection signal 23 from the sensor 22. During this switch, the processing unit 3 can cut off the display of the virtual keyboard.

This sensor 22 is distinct from the means implemented by the touch panel 2 for detecting the touch entry gesture performed by the user U on the touch panel 2: thus a contact on the touch panel 2 will not switch the processing unit 3 into the visually impaired mode. By way of non-limiting example, this sensor 22 is selected from: a radio identification sensor in order to be able to detect an approach of a radio identification badge, a proximity or contact sensor positioned on at least one side of the touch panel 2 in order to be able to detect an approach or a contact of a hand of a user U on the at least one side of the touch panel 2.

In the case of integration of the entry system 1 into the secure access control reader 11, illustrated in FIG. 15, this proximity or contact sensor 22 can be positioned on at least one side of the secure access control reader 11, the touch panel 2 being in turn on the front.

1. An entry system for entering a code comprising a sequence of characters including at least digits, the entry system comprising:
a touch panel configured to generate a contact detection signal in response to a detection of a touch entry gesture performed by a user on the touch panel, the contact detection signal being indicative of contact of one or several fingers on the touch panel during the touch entry gesture;
a processing unit configured to acquire the contact detection signal generated by the touch panel and to select a single character according to the contact detection signal corresponding to the detected touch entry gesture;
wherein the processing unit is configured to operate in an entry mode for selecting digits from a first series of characters comprising all or part of the digits “0” to “9”, by carrying out the following steps of:
identifying that the touch entry gesture is executed in the form of a main drag which corresponds to the drag of at least one finger on the touch panel from a main starting location to a main end location where the main drag is interrupted by removal of the at least one finger, according to the contact detection signal;
determining a drag vector of the main drag, according to the contact detection signal;
selecting a digit of the first series of characters according to the drag vector of the main drag, independently of the main starting location on the touch panel (2).

2. The entry system according to claim 1, wherein the processing unit is configured to determine the drag vector of the main drag as corresponding to a vector from the main starting location to the main end location.

3. The entry system according to claim 1, wherein the main drag corresponds to the drag of a single finger on the touch panel from the main starting location.

4. The entry system according to claim 1, wherein the processing unit is configured to identify that the touch entry gesture is executed in the form of the main drag under the condition that a distance between the main starting location and the main end location is greater than or equal to a given minimum main distance.

5. The entry system according to claim 1, wherein the first series of characters comprises N digits, N being an integer greater than or equal to 2 and less than or equal to 10, and the processing unit is configured to establish N main angular sectors distributed around the main starting location and oriented radially in N distinct main selection directions with a given main central angle, each of the N main angular sectors being associated with a digit of the first series of characters;
and wherein the processing unit is configured to determine whether the drag vector of the main drag is contained in one of the N main angular sectors, and to select the digit of the first series of characters which is associated with the main angular sector.

6. The entry system according to claim 5, wherein the N main angular sectors are contiguous and distributed over 360 degrees around the main starting location, so that the drag vector of the main drag is always contained in one of the N main angular sectors.

7. The entry system according to claim 5, wherein the first series of characters comprises eight digits, N then being equal to 8, which are the digits “1”, “2”, “3”, “4”, “6”, “7”, “8” and “9”, and when placed in a reference frame defined by a horizontal axis and a vertical axis:
the main selection direction associated with the digit “1” is a diagonal direction at 45 degrees relative to the horizontal axis, upward and to the left from the main starting location;
the main selection direction associated with the digit “2” is a vertical direction parallel to the vertical axis, upward from the main starting location;
the main selection direction associated with the digit “3” is a diagonal direction at 45 degrees relative to the horizontal axis, upward and to the right from the main starting location;
the main selection direction associated with the digit “4” is a horizontal direction parallel to the horizontal axis, to the left from the main starting location;
the main selection direction associated with the digit “6” is a horizontal direction parallel to the horizontal axis, to the right from the main starting location;
the main selection direction associated with the digit “7” is a diagonal direction at 45 degrees relative to the horizontal axis, downward and to the left from the main starting location;
the main selection direction associated with the digit “8” is a vertical direction parallel to the vertical axis, downward from the main starting location;
the main selection direction associated with the digit “9” is a diagonal direction at 45 degrees relative to the horizontal axis, downward to the right from the main starting location.

8. The entry system according to claim 1, wherein, in the entry mode, the processing unit is configured to select digits in a second series of characters comprising at least digits distinct from the digits of the first series of characters, by carrying out the following steps of:
identifying that the touch entry gesture is executed in the form of a secondary gesture among several secondary gestures according to the contact detection signal, the several secondary gestures being distinct from the main drag;
selecting a digit of the second series of characters as a function of the detected secondary gesture.

9. The entry system according to claim 8, wherein one of the several secondary gestures is a secondary gesture called centralized gesture which is characterized by pressing at least one finger on a central starting location and by removing the at least one finger on a central end location interrupting the centralized gesture, where the central end location is located in a circular central area centered at the central starting location and having a radius corresponding to a predefined limiting distance;
and wherein the processing unit is configured to select a digit from the second series of characters in response to the identification of the centralized gesture, independently of the central starting location on the touch panel.

10. The entry system according to claim 9, wherein the processing unit is configured to identify that the touch entry gesture is executed in the form of the main drag under the condition that a distance between the main starting location and the main end location is greater than or equal to a given minimum main distance, and wherein the limiting distance is less than or equal to the minimum main distance.

11. The entry system according to claim 9, wherein the second series of characters comprises the digit “5” which is associated with the centralized gesture.

12. The entry system according to claim 9, wherein the processing unit is configured to identify the touch entry gesture as the centralized gesture under the condition that a time interval between pressing the at least one finger on the central starting location and removing the at least one finger from the central end location is greater than a minimum press delay.

13. The entry system according to claim 9, wherein the centralized gesture is a centralized press characterized by maintaining the at least one finger inside the circular central area between the central starting location and the central end location, so that the at least one finger remains inside the circular central area during the centralized press.

14. The entry system according to claim 9, wherein the centralized gesture is a back and forth drag characterized by an exit of the at least one finger outside the circular central area between the central starting location and the central end location, so that the at least one finger exits the circular central area and returns inside the circular central area during the back and forth drag.

15. The entry system according to claim 8, wherein one of the several secondary gestures is a secondary drag which corresponds to the drag of at least one finger on the touch panel from a secondary starting location to a secondary end location where the secondary drag is interrupted by removal of the at least one finger, the secondary drag being distinct from the main drag in that the main drag corresponds to the drag of a first number of fingers comprised between 1 and 4, and the secondary drag corresponds to the drag of a second number of fingers comprised between 1 and 4 and distinct from the first number of fingers;
and wherein the processing unit is configured to:
determine a drag vector of the secondary drag, according to the contact detection signal;
select a digit of the second series of characters according to the drag vector of the secondary drag, independently of the secondary starting location on the touch panel.

16. The entry system according to claim 15, wherein the processing unit is configured to determine the drag vector of the secondary drag as corresponding to a vector from the secondary starting location to the secondary end location.

17. The entry system according to claim 15, wherein the first number of fingers is 1 and the second number of fingers is 2.

18. The entry system according to claim 15, wherein the processing unit is configured to identify that the touch entry gesture is executed in the form of the secondary drag under the condition that a distance between the secondary starting location and the secondary end location is greater than or equal to a given minimum secondary distance.

19. The entry system according to claim 15, wherein the second series of characters comprises the digit “0” and the processing unit is configured to determine whether the drag vector of the secondary drag is contained in a secondary angular sector associated with the digit “0”, centered at the secondary starting location and oriented radially in a secondary selection direction with a given secondary center angle, and to select the digit “0” which is associated with the secondary angular sector.

20. The entry system according to claim 19, wherein the second series of characters also comprises K unencrypted characters, K being an integer greater than or equal to 2, and the processing unit is configured to establish K+1 secondary angular sectors distributed around the secondary starting location and radially oriented in K+1 distinct secondary selection directions with the given secondary center angle, one of the K+1 secondary angular sectors being associated with the digit “0” and the others of the K+1 secondary angular sectors being associated with the respective K unencrypted characters of the second series of characters;
and wherein the processing unit is configured to determine whether the drag vector of the secondary drag is contained in one of the K+1 secondary angular sectors, and to select the digit “0” or the unencrypted character of the second series of characters which is associated with the secondary angular sector.

21. The entry system according to claim 19, wherein the secondary selection direction of the secondary angular sector associated with the digit “0” is, when placed in a reference frame defined by a horizontal axis and a vertical axis, a vertical direction parallel to the vertical axis, downward from the secondary starting location.

22. The entry system according to claim 20, wherein the K unencrypted characters comprise at least a first unencrypted character and a second unencrypted character, and when placed in a reference frame defined by a horizontal axis and a vertical axis:
the secondary selection direction associated with the first unencrypted character is a diagonal direction at 45 degrees relative to the horizontal axis, downward and to the left from the secondary starting location;
the secondary selection direction associated with the second unencrypted character is a diagonal direction at 45 degrees relative to the horizontal axis, downward and to the right from the secondary starting location.

23. The entry system according to claim 22, wherein the first unencrypted character is the special character “*” or a first letter, and the second unencrypted character is the special character “#” or a second letter.

24. The entry system according to claim 1, wherein the processing unit is configured to generate vibratory feedback on the screen and/or an audible feedback when the digit is selected.

25. The entry system according to claim 1, wherein the entry system comprises a display screen positioned behind the touch panel, and the entry system is configured to operate in another entry mode, distinct from the entry mode, in which dedicated locations for entering digits are displayed on or under the touch panel, with one dedicated location per digit, and
in this other entry mode, the processing unit is configured to identify that the touch entry gesture is executed in the form of pressing one of the dedicated locations of the touch panel, and to select the single digit associated with the location.

26. The entry system according to claim 25, comprising at least one sensor connected to the processing unit which is configured to switch from the other entry mode to the entry mode upon receipt of at least one detection signal from the at least one sensor.

27. The entry system according to claim 26, wherein the at least one sensor is distinct from the means implemented by the touch panel for detecting the touch entry gesture performed by the user on the touch panel.

28. The entry system according to claim 27, wherein the at least one sensor comprises a radio identification sensor in order to be able to detect an approach of a radio identification badge.

29. The entry system according to claim 27, wherein the at least one sensor comprises at least one lateral approach sensor shaped to detect an approach or contact of a hand of the user on at least one side of the touch panel.

30. The entry system according to claim 29, wherein the at least one lateral approach sensor is selected from a capacitive sensor, an inductive sensor, a radar sensor, an ultrasonic sensor, an optical sensor, an accelerometer and a mechanical sensor.

31. The entry system according to claim 29, wherein the at least one lateral approach sensor comprises at least one side sensor which is positioned on the at least one side of the touch panel, or at least one front sensor which is positioned on a front face of the touch panel, such a front sensor having a detection field making it possible to detect the approach or contact of the user's hand on the at least one side of the touch panel.

32. The entry system according to claim 25, wherein the processing unit, when in entry mode, is configured to automatically switch from the entry mode to the other entry mode once the sequence of digits forming the code has been selected.

33. A secure access control reader comprising an entry system according to claim 1.

34. An entry method for entering on a touch panel a code comprising a sequence of characters including at least digits, the entry method operating on an entry system according to claim 1, and comprising the following steps of:
generating a contact detection signal in response to a detection of a touch entry gesture performed by a user on the touch panel, the contact detection signal being indicative of contact of one or several fingers on the touch panel during the touch entry gesture;
acquiring by a processing unit the contact detection signal generated by the touch panel;
selecting by the processing unit a single character according to the contact detection signal corresponding to the detected touch entry gesture;
the entry method comprising an entry mode for selecting digits in a first series of characters comprising all or part of the digits “0” to “9”, and wherein the processing unit carries out the following steps of:
identifying that the touch entry gesture is executed in the form of a main drag which corresponds to the drag of at least one finger on the touch panel from a main starting location to a main end location where the main drag is interrupted by removal of the at least one finger, according to the contact detection signal;
determining a drag vector of the main drag, according to the contact detection signal;
selecting a digit of the first series of characters according to the drag vector of the main drag, independently of the main starting location on the touch panel.
